(19) United States
(12) Patent Application Publication
(10) Pub. No.: US 2012/0191823 A1
(43) Pub. Date: Jul. 26, 2012

(54) Software-Implemented Communications Adapter

(75) Inventors: Paulo Chow, North Bend, WA (US); Mark Drovdahl, Seattle, WA (US); Sinclair M. Temple, Seattle, WA (US)

(73) Assignee: T-MOBILE USA, INC., Bellevue, WA (US)

(21) Appl. No.: 13/011,803

(22) Filed: Jan. 21, 2011

(51) Int. Cl. G06F 15/177; H04W 92/18

(52) U.S. Cl. 709/220; 455/90.1

(57) ABSTRACT

A communications adapter is provided for use with or within a user device such as a personal communications device. The communications adapter includes a software defined radio, which can be dynamically configured to allow the user device to communicate with various different radio-enabled devices.

### BACKGROUND

Computer networking has become ubiquitous, with myriads of different computer-like devices now connected to the common network that is known as the Internet. Such devices include traditional computers and accessories, as well as other devices such as telephones and telephonic equipment, media players, book readers, home entertainment systems, office equipment, home appliances, and so forth.

Although many devices continue to rely on wired communication technologies, wireless technologies are increasingly prevalent. In particular, wireless networking technologies are now implemented by a wide range of devices. Many devices also utilize wireless cellular technologies for mobile network connectivity and communications.

Although some standards such as the Wi-Fi™ or IEEE 802.11 protocols have become popular, many other wireless protocols continue to be used, and new wireless spectra continue to be made available for various different types of uses, including non-networking uses.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 is a block diagram illustrating the use of a software-implemented communications adapter implemented within a user communications device.

FIG. 2 is a block diagram illustrating the user of a stand-alone software-implemented communications adapter.

### DETAILED DESCRIPTION

Described herein are components, devices, and techniques that allow user devices, including network-enabled user devices, to communicate with various other radio-enabled or radio-based devices. In some embodiments, this is accomplished through the use of a software-defined radio that is dynamically and programmatically configurable to communicate using a wide range of frequencies, formats, and communication protocols.

In one embodiment, a software-defined radio is implemented within a user device such as a computer or personal communications device. Software interfaces are made available so that installed applications can configure and communicate using the software-defined radio.

In another embodiment, a stand-alone device may be utilized to facilitate communications between a user device and a radio-equipped device. The stand-alone device may have a network interface, a software-defined radio, and remotely accessible software interfaces that can be accessed by the user device to configure the software-defined radio and to communicate with the radio-equipped device.

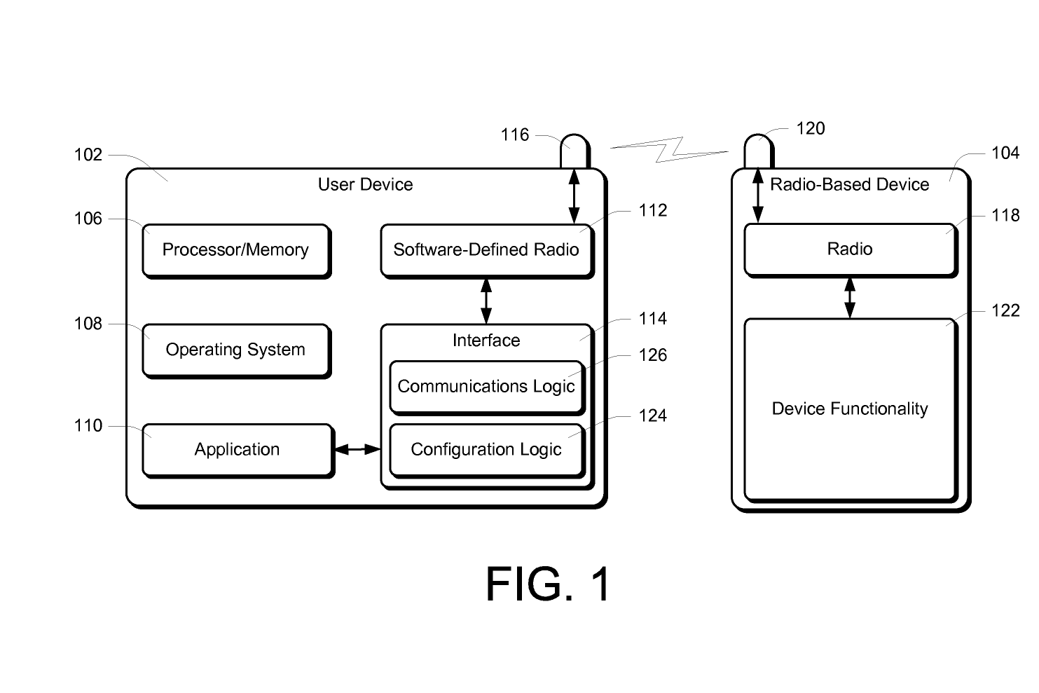

FIG. 1 shows an example implementation that includes a user communications device 102 and a radio-based device 104. The user device may be one of a variety of different types of devices. For example, the user device 102 may comprise a computer or computer-like device such as a desktop computer, a laptop or notebook computer, a netbook computer, a tablet computer, a personal digital assistant (PDA), a cellular telephone or smartphone, a media player, a home entertainment console or device, a security system, a controller or control system, or any other device.

In the example shown, the user device 102 may include a processing unit or processor/memory combination 106, which can be programmed as control logic to implement various functionality depending on the type and intended purpose of the user device 102. Typically, the memory stores programs and/or instructions that are executable by the processor to perform device operations, including the actions and behaviors described below. For example, the memory of a device like this often stores an operating system 108 that is executable by the processor to provide basic functionality. Depending on the particular implementation, the operating system may operate in conjunction with one or more applications 110, which in some cases may be installable by users to provide customized functionality.

The user device 102 may also have a software-defined radio 112 and an associated interface 114. In this example, the interface 114 comprises a software interface through which applications 110 can interact with the software-defined radio 112.

The software-defined radio 112 may be provided in a variety of different forms. Generally, a software-defined radio is one that handles much or all of its signal handling in the digital domain, with a relatively simple digital-to-analog conversion being implemented at a late or final stage of signal processing, prior to an antenna. In practice, different implementations may allocate signal processing in different ways between digital and analog domains. Software-defined radios may be configured for reception, or may be capable of both transmission and reception of radio signals.

In the embodiment of FIG. 1, the software-defined radio 112 is connected to an antenna 116. The antenna 116 may be a traditional antenna suitable for a range of communication frequencies. The antenna 116 may also have associated circuitry and/or components that allow it to be dynamically tuned or optimized for different radio frequencies.

In some embodiments, the antenna 116 may be a software-defined antenna. Software-defined antennas can be implemented using various technologies, including semiconductor fabrication technologies. Software-defined antennas utilize various electronic schemes to variably activate parts of an array to form antenna elements of different configurations. Examples of software-defined or software-configurable antennas include solid-state antennas, semiconductor antennas, silicon antennas, and plasma antennas. The software defined-antenna 116 may in some cases be considered an integral part of the software-defined radio 112.

The software-defined radio 112 and its associated software-defined antenna 116 can be variably and dynamically configured by software executing on the user device 102. Specifically, dynamic configuration of the radio 112 and antenna 116 can be performed by the operating system 108, one or more of the applications 110, the interface 114, or a combination of these components acting in conjunction with each other. Depending on the configuration, the radio 112 and antenna 116 may be dynamically tuned and reconfigured to vary one or more operational properties or parameters, such as modulation frequency, modulation mode, communications protocol, data format, signal format, signal direction, transmission power, reception sensitivity, bandwidth, antenna gain, beam width, and other parameters.

The radio-based device 104 may comprise any one of many different types of devices that interact, communicate, provide information or allow control by means of radio communications. Thus, the radio-based device 104 includes a radio 118 and an associated antenna 120. The radio and antenna may have a fixed or non-variable configuration, such as a configuration that uses a limited selection of frequencies or channels, a single modulation mode, a specific data protocol, and so forth. The radio-based device may be designed to utilize different radio formats and protocols, including digital, analog, broadcast, point-to-point, time-division multiplexing, and so forth.

As an example, the radio-based device 104 may comprise a two-way communications radio that is statically configured to provide analog voice communications using an AM (amplitude modulation) modulation mode on a fixed frequency or limited set of frequencies. As another example, the radio-based device 104 might be a home control device that receives digital commands on a particular frequency, using a specified modulation technique and a specified data format and communications protocol. Such a home control device may also transmit status information, either in response to queries or at periodic intervals.

Other examples of the radio-based device 104 may include appliances, home entertainment equipment, automated industrial equipment, analog and digital communication equipment, toys, telecommunications equipment, computers and computerized devices, remote control vehicles, etc.

The representation of the radio-based device 104 in FIG. 1 includes a block 122 that generally represents the functional components of device 104, which will vary depending on the type of device. Generally, the device functionality 122 interacts with the radio 118 to receive information via the radio 118 and/or to provide information via the radio 118. In some cases, the device functionality 122 may be essentially “read-only,” meaning that it is primarily a source of information, such as status information or current operational information. In other cases, the device functionality may accept commands and/or other control information, and may respond to such information by varying or customizing its operations.

The interface 114 of the user device 102 may include APIs (application programming interfaces) or other configuration logic 124 that are exposed to and accessible by the application 110 to configure the software-defined radio 112. In particular, the application 110 can interact with the configuration logic 124 to set or alter the operating parameters of the software defined radio 112 to match those of the radio-based device 104. If the radio-based device 104 uses a particular modulation type on a particular frequency, for example, the application 110 can specify that particular modulation type and frequency, and the configuration logic 124 will configure the software-defined radio 112 to operate in accordance with those parameters. As mentioned above, controllable or configurable parameters of the software-defined radio may include modulation frequency, modulation mode, data protocol, signal format, signal direction, bandwidth, gain, beam width, and other parameters.

The interface 114 may also include communications APIs or logic 126. The communications logic 126 can be configured to bridge communications between the application 110 and the radio-based device 104. The communications logic 126, for example, may be a communications or protocol stack configured to receive data from the application 110, to format it as expected by the radio-based device 104, and to transmit the data using the software-defined radio 112. The communications logic 126 or protocol stack may also be configured to receive signals or data from the software-defined radio 112, to interpret and/or format the signals or data, and to provide the interpreted or formatted signal or data upon request to the application 110.

The configuration logic in some embodiments may store multiple radio configurations, and may include session control logic that dynamically switches the software-defined radio 112 between the different configurations, to communicate concurrently with a plurality of different radio-enabled devices, each of which may use a different radio format.

In combination, the software-defined radio 112, the antenna 116, and the interface 114 form a communications adapter that allows applications to communicate with various different radio-based devices such as the device 104 of FIG. 1. In operation, any application such as the application 110 can call the interface 114 by means of the configuration logic 124 and communications logic 126, and may configure the software-defined radio 112 and the communications logic 126 for communication with any particular type of external device that may be known to or expected by the application 110. The application 110 may configure the software-defined radio and probe for existing devices, and may change parameters and scan for devices at different frequencies, addresses, and so forth. The application 110 may also configure the communications logic 126 with new or different communication or protocol stacks.

When communications have been established between the application 110 and the radio-based device 104, the application 110 may act as a user interface for the radio-based device 104. For example, the application 110 may present a graphical user interface on a screen of the user device, showing current status and operating parameters of the device 104. The application 110 may also allow a user to interact with the application 110 and with the radio-based device 104. For example, the user may be allowed to specify operating parameters and/or commands to the radio-based device 104.

In addition, or alternatively, the user device may act as a monitor and controller of the radio-based device. It may thus poll the radio-based device 104 for status, and may provide or alter the operational parameters of the device 104 in accordance with pre-defined control strategies or upon selections made by a user of the user device 102.

As a specific example, suppose that the radio-based device 104 is a two-way voice communications device (such as a push-to-talk device or “walkie-talkie”). The application 110 may be a communications application that emulates a two-way radio. In such an example, the application 110 may interact with a microphone of the user device 102 to receive voice signals and transmit them to the radio-based device 104. Similarly, the application 110 may receive voice communications from the radio-based device 104 and render them on the speaker of the user device 102.

As another example, suppose that the radio-based device 104 is some type of remotely controlled equipment, such as a toy vehicle. The application 110 may initially configure the software-defined radio and scan for the presence of any toy vehicles. If found, the application may communicate with the toy vehicle to control its movement, in response to user interaction.

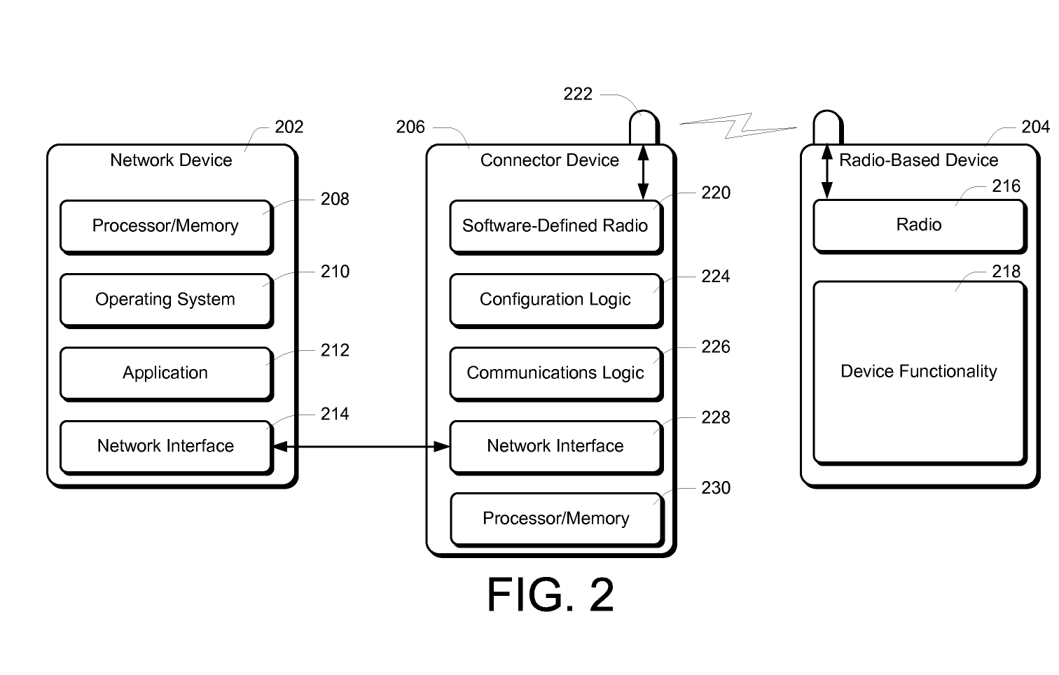

FIG. 2 illustrates another example implementation that includes a network or network-based user device 202, a radio-based device 204, and an independent communications connector or adapter device 206. The user device 202 may be a device such as a desktop computer, a laptop or notebook computer, a netbook computer, a tablet computer, a personal digital assistant (PDA), a smartphone or other form of telecommunications device, a media player, a controller or control system, and so forth.

The user device 202 may include a processing unit or processor/memory combination 208, which may be programmed as control logic to implement various functionality depending on the type and intended purpose of the user device 202. Typically, the memory stores programs and/or instructions that are executable by the processor to perform device operations, including the actions and behaviors described below. For example, the memory of a device like this often stores an operating system 210 that is executable by the processor to provide basic functionality of the user device 202. Depending on the particular implementation, the operating system may operate in conjunction with one or more applications 212, which in some cases may be installable by users to provide customized functionality.

The user device 202 may also have a network communications interface 214 for communications over a network using a computer network communications protocol. The network interface 214 may be a wired interface or a wireless interface such as a WiFi™ interface or cellular communications interface.

The network interface 214 can be configured to allow the user device 202 to communicate using a data network such as a local-area network or a wide-area network. The data network may or may not be part of a public communications network such as the Internet, or may be connected through other communications equipment such as routers and firewalls to the public Internet.

In actual implementation, the user device 202 may of course have more than the single network interface shown, and may also include different types of interfaces.

The radio-based device 204 may be a device like the device 104 described with reference to FIG. 1, having a radio transmitter, receiver, or transceiver 216, and arbitrary device functionality 218. The radio 216 can use any of a number of different radio communication formats and data protocols, and may communicate digital and/or analog data and information. Such information may include audio and video, as well as status and control information and other types of data.

The connector device 206 may be a stand-alone powered unit that is placed in a home or other premises to provide or facilitate communications between the network device 202 and the radio-based device 204. The connector device 206 may have a software-defined radio 220 and antenna 222 as described above with reference to the user device 102 of FIG. 1, forming a communications interface with the radio-enabled device 204. It may also have configuration logic 224 and communications logic 226, as also described above with reference to the user device 102 of FIG. 1.

The connector device 206 may also have a network communications interface 228. The network interface 228 allows the connector device 206 to connect to a local-area or wide-area network such as the Internet, and to therefore communicate with the user device 202. In particular, the configuration logic 224 and the communications logic 226 expose interfaces or APIs that are accessible via the network interface 228 to external devices such as the user device 202. Through these interfaces, the user device 202 can configure the software-defined radio 220 and associated antenna 222 to communicate with a chosen or specified radio-based device 204, or in some cases to communicate concurrently with multiple different radio-based devices.

The functionality of the connector device 206 may be provided by a processor/memory combination 230, which may be programmed to implement and/or store functional components of the connector device 206, such as the antenna 222, the software-defined radio 220, the configuration logic 224, the communications logic 226, and aspects of the network interface 228.

Applications can be designed specifically to take advantage of the combined capabilities offered by the radio-based device 204 and the connector device 206. In the example of a two-way radio, for example, an application can be designed specifically to interact with the two-way radio, after configuring the software-defined radio for this purpose using the configuration logic 224.

Generally, an application running on any network-enabled device, such as user device 202, can interface with the connector device 206 by means of the configuration logic 224 and communications logic 226, and may configure the software-defined radio 220 for communication with any particular type of device that may be known to or expected by the application. The application may configure the software-defined radio and scan for existing devices. In some situations, the application may change parameters of the software-defined radio and scan for devices at different frequencies, addresses, and so forth.

When communications have been established between the application 212 and the radio-based device 204, the application 212 may act as a user interface for the radio-based device 204. For example, the application 212 may present a graphical user interface on a screen of the user device, showing current status and operating parameters of the device 204. The application 212 may also allow a user to interact with the application 212 and with the radio-based device 204, and may act as a monitor and/or controller to the radio-based device 204. Communications with the radio-based device 204 may include control commands, queries, updates, data, information video, audio, and so forth.

From the perspective of an application, the configurations of FIG. 1 and FIG. 2 are similar. In the configuration of FIG. 1, the application interacts with local software components and interfaces to establish communications with the radio-based device. In the configuration of FIG. 2, the application may interact in the same way, except that the interactions are with the remote software components and interfaces of the connector device 206, via network communications.

Using a software-defined radio provides a great degree of flexibility for applications that make use of the provided communications capabilities of either the user device 102 or the connector device 206. The software-defined radio, antenna, and associated control logic can be configured to use a wide variety of radio formats and protocols, including both existing standards and additional formats that will be designed or specified in the future. The communications logic or protocol stack 126 or 226 can similarly be configured to accommodate wide varieties of communications protocols, including protocols that are developed in the future. Such formats and communication protocols may be used for broadcast, point-to-point, and networked communications, and may include both digital and analog communications.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An apparatus comprising:
a data network interface configured for communications with one or more user devices;
a software-defined radio that is configurable to communicate with one or more radio-enabled devices;
configuration logic that is responsive to the one or more user devices to configure the software-defined radio to communicate with at least one of the radio-enabled devices; and
communications logic that bridges communications between the one or more user devices and the one or more radio-enabled devices.

2. An apparatus as recited in claim 1, further comprising session control logic configured to dynamically switch the software-defined radio between different configurations to communicate with a plurality of different radio-enabled devices.

3. An apparatus as recited in claim 1, further comprising a software-defined antenna associated with the software-defined radio.

4. An apparatus as recited in claim 1, further comprising a dynamically configurable antenna associated with the software-defined radio.

5. An apparatus as recited in claim 1, wherein said at least one of the radio-enabled devices comprises a radio-controlled device, the communications comprising control commands.

6. An apparatus as recited in claim 1, wherein the data network interface comprise a wireless network interface.

7. An apparatus as recited in claim 1, wherein the configuration logic is further responsive to applications executing on the one or more user devices to configure the communications logic to bridge communications between the one or more user devices and the one or more radio-enabled devices.

8. An apparatus as recited in claim 1, wherein the data network interface comprise a wireless network interface that communications using a computer network communications protocol.

9. An apparatus as recited in claim 1, wherein the configuration logic is further responsive to the one or more user devices to configure one or more communication parameters of the software-defined radio, the communication parameters including one or more of the following:
modulation frequency;
modulation mode;
communications protocol; and
data format.

10. An apparatus as recited in claim 1, wherein the configuration logic is further responsive to the one or more user devices to configure one or more communication parameters of the software-defined radio, the communication parameters including at least modulation frequency and modulation mode.

11. An apparatus as recited in claim 1, wherein the configuration logic is further responsive to the one or more user devices to configure the software-defined radio to communicate with said at least one of the radio-enabled devices using a broadcast communications protocol.

12. An apparatus as recited in claim 1, wherein the configuration logic is further responsive to the one or more user devices to configure the software-defined radio to communicate with said at least one of the radio-enabled devices using an analog radio format.

13. An apparatus as recited in claim 1, wherein the configuration logic is further responsive to the one or more user devices to configure the software-defined radio to communicate with said at least one of the radio-enabled devices using a digital communications protocol.

14. A user device comprising:
one or more processors;
a software-defined radio that is configurable to communicate with one or more radio-enabled devices external to the user device;
memory communicatively coupled to the processor, the memory being configured to store one or more application programs that are executable by the one or more processors; and
the memory storing configuration logic that is executable by the processor, the configuration logic being responsive to the one or more application programs to configure the software-defined radio to communicate with at least one of the radio-enabled devices.

15. A user device as recited in claim 14, wherein the configuration logic maintains a plurality of radio configurations and dynamically switches the software-defined radio between the radio configurations to communicate with a plurality of the radio-enabled devices.

16. A user device as recited in claim 14, further comprising a software-defined antenna associated with the software-defined radio.

17. A user device as recited in claim 14, further comprising a dynamically configurable antenna associated with the software-defined radio.

18. A user device as recited in claim 14, wherein the application programs are installable by a user of the user device.

19. A user device as recited in claim 14, wherein said at least one of the radio-enabled devices comprises a radio-controlled device, the applications being configured to control said the radio-controlled device.

20. A user device as recited in claim 14, wherein the configuration logic is further responsive to the one or more applications to configure one or more communication parameters of the software-defined radio, the communication parameters including one or more of the following:
modulation frequency;
modulation mode;
communications protocol;
data format;
signal format;
signal direction;
bandwidth;
gain;
transmission power;
reception sensitivity; and
beam width.

21. A user device as recited in claim 14, wherein the configuration logic is further responsive to the one or more applications to configure one or more communication parameters of the software-defined radio, the communication parameters including at least modulation frequency and modulation mode.

22. A user device as recited in claim 14, wherein the configuration logic is further responsive to the one or more applications to configure the software-defined radio to communicate with said at least one of the radio-enabled devices using a broadcast communications protocol.

23. A user device as recited in claim 14, wherein the configuration logic is further responsive to the one or more applications to configure the software-defined radio to communicate with said at least one of the radio-enabled devices using an analog radio format.

24. A user device as recited in claim 14, wherein the configuration logic is further responsive to the one or more applications to configure the software-defined radio to communicate with said at least one of the radio-enabled devices using a digital communications protocol.

25. A user device as recited in claim 14, further comprising:
a data network interface configured for communications with one or more network-based devices; and
wherein the configuration logic is further responsive to the one or more applications to configure the software-defined radio to bridge communications between the one or more network-based devices and the one or more radio-enabled devices.

26. A communications connector comprising:
a first communications interface comprising a software-defined radio having dynamically configurable operational parameters to communicate with radio-enabled devices, the dynamically configurable operational parameters indicating at least radio frequency and modulation mode;
a second communications interface configured to receive the operational parameters from applications; and
communications logic that bridges communications between the applications and the radio-enabled devices.

27. A communications connector as recited in claim 26, further comprising session control logic that dynamically switches the software-defined radio between different configurations to communicate with a plurality of radio-enabled devices using different radio formats.

28. A communications connector as recited in claim 26, wherein the communications logic is responsive to one or more applications to configure the software-defined radio and the communications logic.

29. A communications connector as recited in claim 26, further comprising a software-defined antenna associated with the software-defined radio.

30. A communications connector as recited in claim 26, further comprising a dynamically-configurable antenna associated with the software-defined radio.

31. A communications connector as recited in claim 26, wherein the second communications interface comprises a network interface.

32. A communications connector as recited in claim 26, wherein the second communications interface comprises a wireless network interface.

33. A communications connector as recited in claim 26, wherein the second communications interface comprises a wired network interface.

34. A communications connector as recited in claim 26, wherein the second communications interface comprises a software interface.

35. A communications connector as recited in claim 26, wherein the configuration logic is further responsive to applications to configure the software-defined radio to communicate with the radio-enabled devices using a broadcast communications protocol.

36. A communications connector as recited in claim 26, wherein the configuration logic is further responsive to applications to configure the software-defined radio to communicate with the radio-enabled devices the radio-enabled devices using an analog radio format.

37. A communications connector as recited in claim 26, wherein the configuration logic is further responsive to applications to configure the software-defined radio to communicate with the radio-enabled devices the radio-enabled devices using a digital communications protocol.
